(19) United States
(12) Patent Application Publication
(10) Pub. No.: US 2008/0224092 A1
(43) Pub. Date: Sep. 18, 2008

(54) Etchant for metal

(75) Inventors: Jong-Hyun CHOUNG, Hwaseong-si (KR); Hong-Sick PARK, Suwon-si (KR); Sun-Young HONG, Yongin-si (KR); Bong-Kyun KIM, Nam-gu (KR); Byeong-Jin LEE, Yongin-si (KR); Ji-Sun LEE, Cheonan-si (KR); Ki-Beom LEE, Hwaseong-si (KR); Sam-Young CHO, Hwaseong-si (KR); Byung-Soo KU, Hwaseong-si (KR); Hyun-Cheol SHIN, Hwaseong-si (KR); Kwi-Hong PARK, Hwaseong-si (KR); Won-Guk SEO, Hwaseong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/075,966

(22) Filed: Mar. 14, 2008

(30) Foreign Application Priority Data
Mar. 15, 2007 (KR) 10-2007-0025341
Oct. 16, 2007 (KR) 10-2007-0104166

(51) Int. Cl. C09K 13/08; C09K 13/00

(52) U.S. Cl. 252/79.3; 252/79.1

(57) ABSTRACT

An etchant for a metal is described. In one example, the etchant includes ammonium persulfate ((NH₄)₂S₂O₈), an azole compound and water. The etchant does not include hydrogen peroxide. Thus, the etchant may etch a metal layer including copper so that an etched copper layer has a tapered profile. Furthermore, the etchant may have a high stability to maintain etching ability for a longer time. Thus, manufacturing margins may be improved so that manufacturing costs may be reduced.

### CROSS-REFERENCE TO RELATED APPLICATIONS

This application claims priority under 35 USC §119 to Korean Patent Application No. 2007-25341, filed on Mar. 15, 2007, and Korean Patent Application No. 2007-104166, filed on Oct. 16, 2007 in the Korean Intellectual Property Office (KIPO), the contents of which are herein incorporated by reference in their entirety.

### BACKGROUND OF THE INVENTION

1. Field of the Invention

The present invention relates generally to an etchant for a metal. More particularly, the present invention relates to an etchant for manufacturing a thin-film transistor liquid crystal display (TFT-LCD) device.

2. Description of the Related Art

Liquid crystal display (LCD) devices typically have high resolutions to display clear images. The LCD devices have characteristics such as thicker structures, lower power consumption, lower driving voltages, etc., in comparison with other types of display devices, such as cathode ray tube (CRT) devices, plasma display panel (PDP) devices and so on. An LCD device may be driven by an electric circuit, for example, a thin-film transistor (TFT) circuit. Manufacturing processes of a TFT-LCD device include a deposition process that includes depositing a metal layer using a material for source/drain electrodes, and an etching process that includes selectively removing the metal layer using a corrosive gas or a corrosive liquid to form a metal line of an electric circuit.

A plurality of thin layers or thin films may be disposed on a TFT substrate. Thus, a metal line of the TFT substrate may preferably have a gentle tapered shape, of which an etching profile slopes down uniformly, and a lower width of the metal line is wider than an upper width of the metal line. A step difference between the thin layers may be reduced when the etching profile of the metal line has a gentle tapered shape. When a shape of the etched metal line is not uniform and not fine, the resolution of the TFT-LCD device may be decreased, and colors displayed on the TFT-LCD device may not be accurate. Examples of an etching method include a dry-etching method using a gas and a wet-etching method using an etching solution. Even though the wet-etching method has a few disadvantages, the wet-etching method has been steadily used since the wet-etching method has advantages, such as low manufacturing costs for processes, the non-requirement of maintaining an etching environment in a high vacuum state, a high etching selectivity with respect to a mask and a substrate, etc.

Active research is being conducted on the miniaturization and integration of electrical circuits in the electronic technology field including TFTs. As an electrical circuit is miniaturized and integrated, a line width of the electrical circuit is reduced. Thus, electric resistance may be relatively increased to cause resistance-capacitance (RC) signal delay. The electric resistance needs to be maintained at a low level in order to increase the sizes and resolutions of LCD panels according to recent trends. In order to reduce the RC signal delay to increase the sizes of LCD panels, a low resistance material needs to be developed. Conventional materials, for example, chromium, molybdenum, aluminum, alloys thereof, etc., have relatively high resistance, and thus they are inappropriate for a metal line of a large-sized TFT-LCD panel.

Copper has low resistance and is easily and economically used. Thus, the resistance of a metal line formed from a copper layer is much less than that of a metal line formed from an aluminum layer or a chromium layer. Furthermore, copper is more environmentally friendly than aluminum or chromium. However, copper has relatively high resistance against oxidizers compared to aluminum or chromium. Thus, an etching solution including a stronger oxidizer needs to be used for etching a copper layer. Examples of the stronger oxidizer include hydrogen peroxide (H₂O₂), an iron(III) oxidizer, etc.

With regard to using hydrogen peroxide as an oxidizer for etching a copper layer, Korean Laid-Open Patent Publication No. 2000-079355 describes a mixture of hydrogen peroxide and an inorganic acid or a neutral salt, and Korean Laid-Open Patent Publication No. 2005-000682 describes a mixture of hydrogen peroxide, a copper-reaction inhibitor, a stabilizer for hydrogen peroxide and a fluoride compound. Furthermore, Korean Laid-Open Patent Publication No. 2006-064881 describes a mixture of hydrogen peroxide and five additives including a fluoride compound and an organic molecule, etc.

With regard to using an iron(III) oxidizer as an oxidizer for etching a copper layer, Korean Laid-Open Patent Publication No. 2000-032999 describes a mixture of iron(III) chloride hexahydrate and hydrofluoric acid. Furthermore, Korean Laid-Open Patent Publication No. 1999-017836 describes an invention using a conventional etching solution including phosphoric acid, nitric acid and acetic acid.

However, the above-mentioned etching solutions have disadvantages. For example, a semiconductor substrate having a metal layer different from a copper layer may be etched too quickly, or a tapered profile of an etched metal layer may include an angle greater than 90 degrees. Furthermore, hydrogen peroxide may cause disproportionation in the presence of a copper ion and an iron ion to be decomposed into water and oxygen (referring to U.S. Pat. No. 4,140,772). The disproportionation may cause heat and rapid changing of compositions to deteriorate manufacturing process margins and stability. In order to solve the above-mentioned problems, hydrogen peroxide may be used with a stabilizer for hydrogen peroxide, which may increase manufacturing costs.

### SUMMARY OF THE INVENTION

The present invention provides an etchant for a metal, which is capable of improving etching process margins and stability, and uniformly taper-etching a metal layer including copper.

In one aspect of the present invention, an etchant includes ammonium persulfate ((NH₄)₂S₂O₈) and an azole compound.

The content of ammonium persulfate may be about 0.1% to about 50% by weight based on a total weight of the etchant, and the content of the azole compound may be about 0.01% to about 5% by weight based on a total weight of the etchant.

The etchant may further include a fluoride compound.

The etchant may further include a nitrate compound including nitric acid and/or nitrates, a sulfate compound including sulfuric acid and/or sulfates, a phosphate compound including phosphoric acid and/or phosphates, an acetate compound including acetic acid and/or acetates, etc.

The etchant may further include a sulfonate compound.

The etchant may further include a chelating agent.

According to the above, an etchant according to an example embodiment of the present invention may not use hydrogen peroxide. Thus, the etchant may not cause problems such as generation of heat, decrease in stability, the requirement of expensive stabilizer, etc. Thus, the etchant may etch a metal layer including copper so that an etched copper layer has a tapered profile. Furthermore, the etchant may have a high stability to maintain etching ability for a longer time. Thus, manufacturing margins may be improved so that manufacturing costs may be reduced.

### BRIEF DESCRIPTION OF THE DRAWINGS

The above and other advantages of the present invention will become readily apparent by reference to the following detailed description when considered in conjunction with the accompanying drawings wherein:

FIG. 1 is a microscope picture illustrating a profile of a copper layer etched by an etchant of Example 1 through a 30% over-etching experiment;

FIG. 2 is a microscope picture illustrating a profile of a copper layer etched by an etchant of Example 2 through a 30% over-etching experiment;

FIG. 3 is a microscope picture illustrating a profile of a copper layer etched by an etchant of Example 3 through a 30% over-etching experiment; and

FIG. 4 is a microscope picture illustrating a profile of a copper layer etched by an etchant of Example 4 through a 30% over-etching experiment.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An etchant according to an example embodiment of the present invention includes ammonium persulfate ((NH₄)₂S₂O₈), an azole compound and water.

In example embodiments, water occupies a remainder of a total weight (100%), from which components except for water are excluded. In example embodiments, ultra-pure water or water having a degree of purity, which may be used for manufacturing a semiconductor, may be preferred.

Etchant

Ammonium persulfate of an etchant according to example embodiments of the present invention may serve as an oxidizer to etch a metal layer including a copper layer. Ammonium persulfate having a degree of purity, which may be used for manufacturing a semiconductor, may be preferred. In one example, the etchant includes about 0.1% to about 50% by weight of ammonium persulfate based on a total weight of the etchant.

An azole compound includes a pentagonal hetero ring containing a nitrogen atom and at least one atom different from carbon. Examples of the azole compound may include benzotriazole, aminotetrazole, imidazole, pyrazole, etc. These can be used alone or in a combination thereof. The etchant includes about 0.01% to about 5% by weight of the azole compound. The azole compound may serve to inhibit etching of copper in a metal layer including copper. When the etchant is provided to a multilayer structure including a copper layer and an additional layer formed on and/or under the copper layer, the additional layer including a metal different from copper, the azole compound may control an etching ratio difference between the copper layer and the additional layer. For example, the additional layer may include titanium. The azole compound reduces cut dimension (CD) loss. Thus, a metal line may be used for a gate line and/or a data line. When the etchant does not include the azole compound, an etching ratio with respect to a copper layer may not be controlled, and CD loss may be increased and a linearity of a metal line may be deteriorated to cause serious problems.

The etchant may further include a fluoride compound containing fluorine. In one example, the content of the fluoride compound is about 0.01% to about 10% by weight based on a total weight of the etchant. The fluoride compound may serve as an oxidizing supporter for the etchant to increase an etching ratio with respect to a metal layer including copper. Furthermore, the fluoride compound may etch a metal layer including titanium. Examples of the fluoride compound may include hydrofluoric acid, ammonium fluoride, ammonium bifluoride, potassium fluoride, sodium fluoride, etc. These can be used alone or in a combination thereof.

The etchant according to an example embodiment of the present invention may further include an oxidizing controller, for example, a nitrate compound including nitric acid and/or nitrates, a sulfate compound including sulfuric acid and/or sulfates, a phosphate compound including phosphoric acid and/or phosphates, an acetate compound including acetic acid and/or acetates, etc. These can be used alone or in a combination thereof. The etchant may not include the oxidizing controller.

The nitrate compound may generate a nitrate ion (NO₃⁻) in the etchant. In one example, the content of the nitrate compound is no more than about 10% by weight based on a total weight of the etchant. Examples of the nitrate compound may include nitric acid, iron nitrate(III) (Fe(NO₃)₃), potassium nitrate, ammonium nitrate, lithium nitrate, etc. These can be used alone or in a combination thereof.

The sulfate compound may generate a sulfate ion (SO₄²⁻) and/or a hydrogen sulfate ion (HSO₄⁻) in the etchant. In one example, the content of the sulfate compound is no more than about 10% by weight based on a total weight of the etchant. The sulfate compound may form an appropriate taper angle of a metal layer including copper, for example about 30 degrees to about 60 degrees, to improve step coverage in after-processes so that yield is increased. Furthermore, the sulfate compound may increase an etching ratio with respect to copper to improve the manufacturing efficiency of an etching process. The etchant may etch copper without the sulfate compound. However, when the etchant includes the sulfate compound, a taper angle of an etched metal layer may be maintained properly so that step coverage of an upper layer formed on the etched metal layer may be prevented from being deteriorated. Thus, defects may be reduced and/or prevented. Examples of the sulfate compound may include sulfuric acid, ammonium hydrogen sulfate (NH₄HSO₄), potassium hydrogen sulfate (KHSO₄), dipotassium sulfate (K₂SO₄), etc. These can be used alone or in a combination thereof.

The phosphate compound may generate a phosphate ion (PO₄³⁻), a hydrogen phosphate ion (HPO₄²⁻), a dihydrogen phosphate ion (H₂PO₄⁻), etc. in the etchant. In one example, the content of the phosphate compound is no more than 10% by weight based on a total weight of the etchant. Examples of the phosphate compound may include phosphoric acid, triammonium phosphate ((NH₄)₃PO₄), diammonium hydrogen phosphate ((NH₄)₂HPO₄), ammonium dihydrogen phosphate (NH₄H₂PO₄), tripotassium phosphate (K₃PO₄), dipotassium hydrogen phosphate (K₂HPO₄), potassium dihydrogen phosphate (KH₂PO₄), trisodium phosphate (Na₃PO₄), disodium hydrogen phosphate (Na₂HPO₄), sodium dihydrogen phosphate (NaH₂PO₄), etc. These can be used alone or in a combination thereof. The etchant including the phosphate compound may uniformly etch a metal layer including copper.

The acetate compound may generate an acetate ion (CH₃COO⁻) in the etchant. In one example, the content of the acetate compound is no more than 10% by weight based on a total weight of the etchant. Examples of the acetate compound may include acetic acid, ammonium acetate, potassium acetate, sodium acetate, iminodiacetic acid (HN(CH₂COOH)₂, IDA), etc. These can be used alone or in a combination thereof. The acetate compound may increase the stability of the etchant and may maintain etching ability of the etchant.

The etchant may further include a sulfonate compound including sulfonic acid. In one example, the content of the sulfonate compound is about 0.01% to about 10% by weight based on a total weight of the etchant. The sulfonate compound may inhibit decomposition of ammonium persulfate to improve the stability of the etchant. Examples of the sulfonate compound may include benzenesulfonic acid, para-toluenesulfonic acid, methanesulfonic acid, amidosulfonic acid, etc.

The etchant may further include a chelating agent. In one example, the content of the sulfonate compound is about 0.0001% to about 5% by weight based on a total weight of the etchant. When the etchant etches a metal layer including copper, the chelating agent in the etchant is coupled to a copper ion generated in the course of the etching process to prevent the copper ion from affecting the etching rate of the etchant. Examples of the chelating agent may include a phosphonic chelating compound, a sulfonic chelating compound, an acetate chelating compound, etc.

Although the example embodiments of the present invention have been described, it is understood that the present invention should not be limited to these example embodiments but various changes of the contents and substitutions of the components can be made by one ordinary skilled in the art within the spirit and scope of the present invention.

The invention is described more fully hereinafter with reference to examples. This invention may, however, be embodied in many different forms and should not be construed as limited to the examples. Rather, these examples are provided so that this disclosure will be thorough and complete, and will fully convey the scope of the invention to those skilled in the art.

Examples of Etchant

Examples 1 to 4 were prepared according to the following Table 1. Compositions of Examples 1 to 4 are described in Table 1. Contents of components are based on % by weight.

TABLE 1

| Components | Example 1 | Example 2 | Example 3 | Example 4 |
|---|---|---|---|---|
| Ammonium persulfate | 2% | 3% | 3% | 3% |
| Azole Compound | 0.7% | 0.1% | 0.1% | — |
| Nitrate compound | 1% | — | — | — |
| Sulfate compound | — | 0.5% | — | — |
| Phosphate compound | — | — | 0.5% | — |
| Acetate compound | — | — | — | 0.5% |

| | |
|---|---|
| Water | Remainder to fill 100% |

Referring to Table 1, an etchant of Example 1 includes about 2% by weight of ammonium persulfate, about 0.7% by weight of the azole compound, about 1% by weight of the nitrate compound and a remainder of water.

An etchant of Example 2 includes about 3% by weight of ammonium persulfate, about 0.1% by weight of the azole compound, about 0.5% by weight of the sulfate compound and a remainder of water.

An etchant of Example 3 includes about 3% by weight of ammonium persulfate, about 0.1% by weight of the azole compound, about 0.5% by weight of the phosphate compound and a remainder of water.

An etchant of Example 4 includes about 3% by weight of ammonium persulfate, about 0.5% by weight of the acetate compound and a remainder of water.

Examples 5 to 13 were prepared according to the following Table 2. Compositions of Examples 5 to 13 are described in Table 2. Contents of components are based on % by weight.

TABLE 2

| | Example | | | | | | | | |
|---|---|---|---|---|---|---|---|---|---|
| Components | 5 | 6 | 7 | 8 | 9 | 10 | 11 | 12 | 13 |
| Ammonium | 5% | 5% | 5% | 5% | 5% | 5% | 5% | 5% | 5% |
| persulfate | | | | | | | | | |
| Azole compound | 0.5% | 0.5% | 0.5% | 0.5% | 0.5% | 0.5% | 0.5% | 0.5% | 0.5% |
| Fluoride compound | 0.2% | 0.5% | 0.7% | 0.2% | 0.2% | 0.2% | 0.2% | 0.2% | 0.2% |
| Nitrate compound | 1% | 1% | 1% | 1% | 1% | 1% | — | — | — |
| Sulfate compound | — | — | — | — | — | — | 1% | — | — |
| Phosphate | — | — | — | — | — | — | — | 1% | — |
| compound | | | | | | | | | |
| Acetate compound | 1% | 1% | 1% | 1% | — | — | — | — | 1% |
| Sulfonate | 0.2% | 0.2% | 0.2% | 0.2% | 0.5% | 0.2% | 0.2% | 0.2% | 0.2% |
| compound | | | | | | | | | |
| Chelating agent | 0.001% | 0.001% | 0.001% | 0.01% | 0.001% | 0.001% | 0.001% | 0.001% | 0.001% |

| | |
|---|---|
| Water | Remainder to fill 100% |

Referring to Table 2, an etchant of Example 5 includes about 5% by weight of ammonium persulfate, about 0.5% by weight of the azole compound, about 0.2% by weight of the fluoride compound, about 1% by weight of the nitrate compound, about 1% by weight of the acetate compound, about 0.2% by weight of the sulfonate compound, about 0.001% by weight of the chelating agent and a remainder of water.

An etchant of Example 6 includes about 5% by weight of ammonium persulfate, about 0.5% by weight of the azole compound, about 0.5% by weight of the fluoride compound, about 1% by weight of the nitrate compound, about 1% by weight of the acetate compound, about 0.2% by weight of the sulfonate compound, about 0.001% by weight of the chelating agent and a remainder of water.

An etchant of Example 7 includes about 5% by weight of ammonium persulfate, about 0.5% by weight of the azole compound, about 0.7% by weight of the fluoride compound, about 1% by weight of the nitrate compound, about 1% by weight of the acetate compound, about 0.2% by weight of the sulfonate compound, about 0.001 % by weight of the chelating agent and a remainder of water.

An etchant of Example 8 includes about 5% by weight of ammonium persulfate, about 0.5% by weight of the azole compound, about 0.2% by weight of the fluoride compound, about 1% by weight of the nitrate compound, about 1% by weight of the acetate compound, about 0.2% by weight of the sulfonate compound, about 0.01% by weight of the chelating agent and a remainder of water.

An etchant of Example 9 includes about 5% by weight of ammonium persulfate, about 0.5% by weight of the azole compound, about 0.2% by weight of the fluoride compound, about 1% by weight of the nitrate compound, about 0.5% by weight of the sulfonate compound, about 0.001% by weight of the chelating agent and a remainder of water.

An etchant of Example 10 includes about 5% by weight of ammonium persulfate, about 0.5% by weight of the azole compound, about 0.2% by weight of the fluoride compound, about 1% by weight of the nitrate compound, about 0.2% by weight of the sulfonate compound, about 0.001% by weight of the chelating agent and a remainder of water.

An etchant of Example 11 includes about 5% by weight of ammonium persulfate, about 0.5% by weight of the azole compound, about 0.2% by weight of the fluoride compound, about 1% by weight of the sulfate compound, about 0.2% by weight of the sulfonate compound, about 0.001% by weight of the chelating agent and a remainder of water.

An etchant of Example 12 includes about 5% by weight of ammonium persulfate, about 0.5% by weight of the azole compound, about 0.2% by weight of the fluoride compound, about 1% by weight of the phosphate compound, about 0.2% by weight of the sulfonate compound, about 0.001% by weight of the chelating agent and a remainder of water.

An etchant of Example 13 includes about 5% by weight of ammonium persulfate, about 0.5% by weight of the azole compound, about 0.2% by weight of the fluoride compound, about 1% by weight of the acetate compound, about 0.2% by weight of the sulfonate compound, about 0.001% by weight of the chelating agent and a remainder of water.

Experiment—Evaluation of Etching Ability

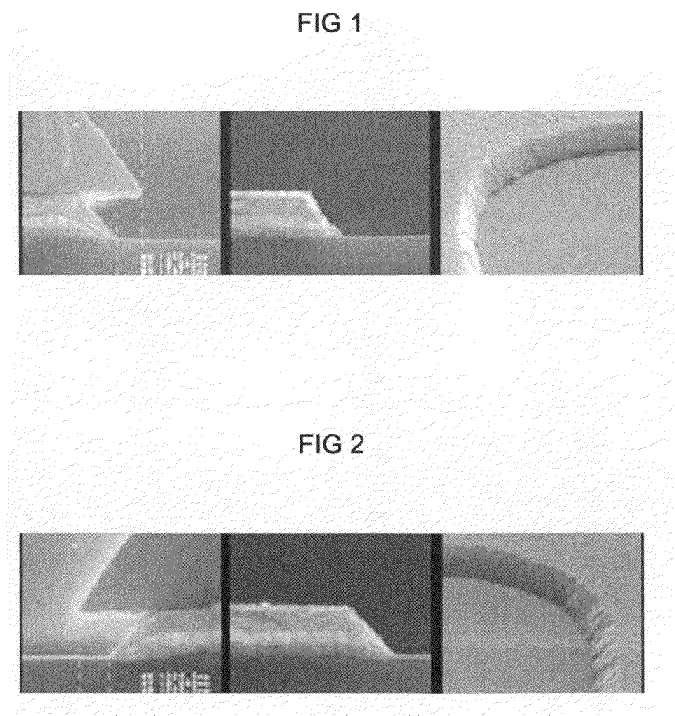

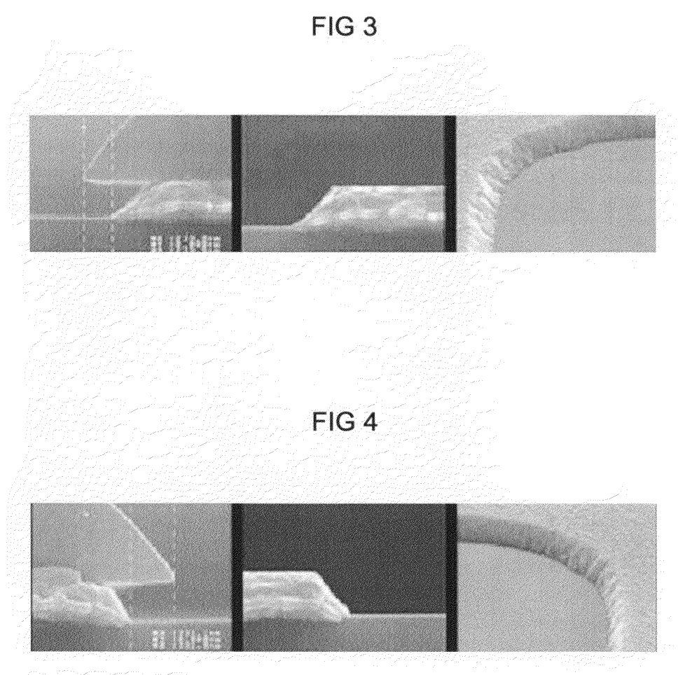

Each of the etchants of Examples 1 to 4 was provided to a copper single layer formed on a glass substrate to evaluate etching ratios, cut dimension (CD) skews and taper angles, and the copper single layers were over-etched by about 30% based on an etching time. Furthermore, a profile of each etched copper single layer was observed by a microscope. Obtained results are tabulated in the following Table 3 and illustrated in FIGS. 1 to 4. FIG. 1 is a microscope picture illustrating a profile of a copper layer etched by an etchant of Example 1 through a 30% over-etching experiment. FIG. 2 is a microscope picture illustrating a profile of a copper layer etched by an etchant of Example 2 through a 30% over-etching experiment. FIG. 3 is a microscope picture illustrating a profile of a copper layer etched by an etchant of Example 3 through a 30% over-etching experiment. FIG. 4 is a microscope picture illustrating a profile of a copper layer etched by an etchant of Example 4 through a 30% over-etching experiment.

TABLE 3

| | End Point of | | |
|---|---|---|---|
| | Etching (sec) | CD Skew (μm) | Taper Angle (°) |
| Example 1 | 25 | 0.2 | 47 |
| Example 2 | 35 | 0.2 | 42 |
| Example 3 | 40 | 0.2 | 40 |
| Example 4 | 45 | 0.3 | 50 |

The end point of etching corresponds to a lapse of time until the copper single layers were completely etched to expose the glass substrate. As the end point of etching decreases, etching ability increases. The CD skew corresponds to a distance between an end of the copper single layer and an end of a photoresist pattern formed on the copper single layer. The CD skew needs to be within an appropriate range so that a step difference may be prevented and so that the etched copper singe layer may have a uniform tapered profile. The taper angle is an angle of each etched copper single layer, which was observed from a side view. A preferable taper angle may be about 45 degrees to about 60 degrees. Referring to Table 3, it can be noted that Examples 1 to 4 have high etching ratios and proper CD skews. Furthermore, it can be noted that Examples 1 to 4 may form a tapered profile with about 30 degrees to about 70 degrees. As illustrated in FIGS. 1 to 4, the copper single layers etched by Example 1 to 4 have high linearity and stability. Thus, the etchants according to example embodiments of the present invention may maintain etching ability for etching a number of copper layers.

Each of the etchants of Examples 5 to 13 was provided to a copper single layer formed on a glass substrate to evaluate etching ratios, cut dimension (CD) skews and taper angles, and the copper single layers were over-etched by about 30% based on an etching time. Obtained results are tabulated in the following Table 4.

TABLE 4

| | End Point of | CD | |
|---|---|---|---|
| | Etching (sec) | skew (μm) | Taper Angle (°) |
| Example 5 | 35 | 0.2 | 47 |
| Example 6 | 40 | 0.2 | 42 |
| Example 7 | 45 | 0.2 | 40 |
| Example 8 | 60 | 0.3 | 50 |
| Example 9 | 28 | 0.3 | 45 |
| Example 10 | 25 | 0.2 | 40 |
| Example 11 | 30 | 0.2 | 38 |
| Example 12 | 40 | 0.3 | 60 |
| Example 13 | 50 | 0.2 | 50 |

Referring to Table 4, it can be noted that etchants of Examples 5 to 13 have high etching ratios and proper CD skews. Furthermore, it can be noted that etchants of Examples 5 to 13 may form a tapered profile of about 30 degrees to about 70 degrees.

According to the above, an etchant according to an example embodiment of the present invention may not use hydrogen peroxide. Thus, the etchant may not cause problems such as generation of heat, decrease in stability, the requirement of expensive stabilizer, etc. Thus, the etchant may etch a metal layer including copper so that an etched copper layer has a tapered profile. Furthermore, the etchant may have a high stability to maintain etching ability for longer time. Thus, manufacturing margins may be improved so that manufacturing costs may be reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An etchant for a metal, comprising:
about 0.1% to about 50% by weight of ammonium persulfate;
about 0.01% to about 5% by weight of an azole compound; and
water.

2. The etchant of claim 1, wherein the azole compound comprises at least one selected from the group consisting of benzotriazole, aminotetrazole, imidazole and pyrazole.

3. The etchant of claim 1, further comprising a fluoride compound containing fluorine.

4. The etchant of claim 3, wherein the content of the fluoride compound is about 0.01% to about 10% by weight.

5. The etchant of claim 4, wherein the fluoride compound comprises at least one selected from the group consisting of hydrofluoric acid, ammonium fluoride, ammonium bifluoride, potassium fluoride and sodium fluoride.

6. The etchant of claim 3, further comprising at least one selected from the group consisting of no more than about 10% by weight of a nitrate compound, no more than about 10% by weight of a sulfate compound, no more than about 10% by weight of a phosphate compound and no more than about 10% by weight of an acetate compound, the nitrate compound including nitric acid and/or a nitrate, the sulfate compound including sulfuric acid and/or a sulfate, the phosphate compound including phosphoric acid and/or a phosphate, and the acetate compound including acetic acid and/or an acetate.

7. The etchant of claim 6, wherein the nitrate compound comprises at least one selected from the group consisting of nitric acid, iron nitrate(III) (Fe(NO₃)₃), potassium nitrate, ammonium nitrate and lithium nitrate.

8. The etchant of claim 6, wherein the sulfate compound comprises at least one selected from the group consisting of sulfuric acid, ammonium hydrogen sulfate (NH₄HSO₄), potassium hydrogen sulfate (KHSO₄) and dipotassium sulfate (K₂SO₄).

9. The etchant of claim 6, wherein the phosphate compound comprises at least one selected from the group consisting of phosphoric acid, triammonium phosphate ((NH₄)₃PO₄), diammonium hydrogen phosphate ((NH₄)₂HPO₄), ammonium dihydrogen phosphate (NH₄H₂PO₄), tripotassium phosphate (K₃PO₄), dipotassium hydrogen phosphate (K₂HPO₄), potassium dihydrogen phosphate (KH₂PO₄), trisodium phosphate (Na₃PO₄), disodium hydrogen phosphate (Na₂HPO₄) and sodium dihydrogen phosphate (NaH₂PO₄)

10. The etchant of claim 6, wherein the acetate compound comprises at least one selected from the group consisting of acetic acid, ammonium acetate, potassium acetate, sodium acetate and iminodiacetic acid (HN(CH₂COOH)₂, IDA)

11. The etchant of claim 5, further comprising a sulfonate compound including sulfonic acid.

12. The etchant of claim 11, wherein the content of the sulfonate compound is about 0.001% to about 10% by weight.

13. The etchant of claim 12, wherein the sulfonate compound comprises at least one selected from the group consisting of benzenesulfonic acid, para-toluenesulfonic acid, methanesulfonic acid and amidosulfonic acid.

14. The etchant of claim 11, further comprising a chelating agent.

15. The etchant of claim 14, wherein the content of the chelating agent is about 0.0001% to about 5% by weight.

16. The etchant of claim 15, wherein the chelating agent comprises at least one selected from the group consisting of a phosphonic chelating compound, a sulfonic chelating compound and an acetate chelating compound.

17. An etchant for a metal, comprising:
about 0.1% to about 50% by weight of ammonium persulfate;
about 0.01% to about 5% by weight of an azole compound;
water; and
no hydrogen peroxide.
